(19) United States
(12) Patent Application Publication
(10) Pub. No.: US 2005/0214417 A1
(43) Pub. Date: Sep. 29, 2005

(54) Animal protein products usable as ingredients in extruded products

(76) Inventors: Rick A. Aberle, Sabetha, KS (US); Gordon R. Huber, Sabetha, KS (US)

Correspondence Address: HOVEY WILLIAMS LLP, 2405 GRAND BLVD., SUITE 400, KANSAS CITY, MO, 64108, US

(21) Appl. No.: 10/812,231

(22) Filed: Mar. 29, 2004

(51) Int. Cl. A23B 4/00

(52) U.S. Cl. 426/129

(57) ABSTRACT

Methods of preparing fresh animal protein products of consistent composition and specification useful as ingredients in extrusion systems are provided, wherein one or more aqueous streams (10, 54, 56) of fresh, uncooked animal protein and fat are initially blended (12, 60) and emulsified (14, 62). The emulsified and blended streams (10, 54, 56) include solid particles having a maximum dimension of up to about 2 mm. These materials are analyzed preferably using near infrared and microwave analyzers (16, 64, 68) and an output stream (18, 70) is created. The analyzers (16, 64, 68) create product signatures for the analyzed materials which is used to adjust the specification of the materials via recirculation (42), addition of fresh animal protein (10) or other ingredients (30) in a batch system; or by appropriate mixing of individual streams (54, 56) in a continuous mixer (66).

### BACKGROUND OF THE INVENTION

1. Field of the Invention

The present invention is broadly concerned with improved, consistent quality animal fresh animal protein products which can be provided to processors of extruded feeds for inclusion in such feeds. More particularly, the invention is concerned with products of this type, as well as methods of preparation thereof, wherein the products may be produced on-site by the processor, or may be containerized in sealed containers permitting the products to be stored at room temperature without spoilage for considerable periods.

2. Description of the Prior Art

Many pet food products and diets manufactured in today's pet food industry include fresh animal proteins as a part of their formulation. Many advantages are gained by including such fresh animal proteins, including the opportunity to realize premium prices at retail, increased customer appeal, superior palatability to the pet, and improved ranges of nutritional sources for a given diet.

Manufacturing a feed with animal protein therein raises a number of problems for the extrusion processor. These can include problems in warehousing of raw ingredients, ingredient spoilage, lack of consistency in the protein products (especially protein, fat and moisture levels), the need for extensive pre-extrusion preparation of the ingredients to obtain consistent particle sizes and viscosities, and the need to have special metering and conveying devices for the proteinaceous ingredients.

Dealing with these issues results in high expense levels for the producer, both in terms of capital equipment and day-to-day operating expense. For example, significant space and equipment must be dedicated to avoid ingredient waste. Moreover, variation in the consistency of protein, fat and moisture in the ingredients between batches means that the producer must constantly monitor these parameters and adjust the extrusion process accordingly. Thus, if moisture levels vary significantly, the extrusion operation must be modified to lessen the amount of added water at the extruder, else the final extruded product will be difficult to produce or will be out of specification.

Currently, fresh animal protein ingredients are purchased by the pet food manufacturer in a form either frozen in blocks or in a partially frozen slurry. This requires a significant investment in freezer warehouse space to store the products before processing. It also necessitates grinding, conveying, emulsifying and tempering equipment which is often necessary to produce a suitable input stream to the extrusion system.

Therefore, there is a decided need in the art for improved animal protein products and processes capable of overcoming these issues and giving the feed processor a consistent quality protein ingredient which not only meets the processor's specifications but also maintains these specifications on a day-to-day basis.

### SUMMARY OF THE INVENTION

The present invention overcomes the problems outlined above and provides greatly improved fresh animal protein products which can be consistently produced on a day-to-day basis with very reproducible characteristics such as protein, fat and moisture contents, and pH levels. In this way, producers of pet foods can obtain consistent animal protein ingredients having specific desired characteristics for their extrusion operations. As a consequence, such producers will no longer be required to change or adjust their extrusion operations so that overall quality and efficiency is enhanced.

Broadly speaking, the animal protein products of the invention are provided in containers sealed against entrance of atmospheric air, with the containers including respective quantities of fresh, uncooked animal-containing material. Although the particular attributes of such material may vary within limits, generally speaking the animal protein material will contain from about 45-80% by weight water (more preferably from about 50-70% by weight), up to about 50% by weight protein (more preferably from about 8-18% by weight), up to about 40% by weight fat (more preferably from about 8-20% by weight), and up to about 6% by weight ash (more preferably from about 1-3% by weight). Moreover, the aqueous animal protein material within the container should have a pH of from about 4-5.5, and more preferably from about 4.3-4.8. The container should contain less than about 5% by weight free oxygen, and more preferably less than about 2% by weight thereof. A particular advantage of the containerized products is that they are storable within the container at room temperature and without spoilage for a period of at least about 7 days, more preferably at least about 30 days.

The starting animal protein material can be selected from a variety of sources, e.g., poultry (chicken or turkey, for example), beef, pork, lamb or mixtures thereof. Normally, the animal protein materials used for pet food or other animal feeds represent products unsuitable for human consumption such as MDM meats, livers, hearts, spleens, muscle or fat trimmings and bony cuts.

The processes of the invention can be either batch or continuous in nature. Generally, however, the processes involve first providing an incoming aqueous (i.e., containing either naturally occurring or added water) stream of material including fresh, uncooked animal protein and fat. This incoming stream is first blended in a blender with the optional addition of additives such as water, fat, tallow, nutraceuticals, and/or other proteins such as grain- or legume-derived or dairy proteins. After blending, the material is then emulsified so that the stream includes particles having a maximum dimension of up to about 7 mm, more preferably up to about 1.5 mm. After emulsification, the material is analyzed using one or more analyzers to determine at least the moisture content thereof, and more preferably moisture content, protein content, fat content and pH. An output stream is then generated downstream of the analyzer. However, the characteristics of this output stream are adjusted as necessary in response to the analysis step by the addition of further quantities of animal protein material and/or fat and/or other additives, the goal being to ensure that the output stream has the specified characteristics for the customer. Such adjustment may be effected by recirculating a portion of the analyzed stream back to the blender for mixing with additional incoming quantities of animal protein material; this is common with batch processes. In the case of continuous processes, the analyzed stream may be mixed with another stream of similarly produced and analyzed material to create the final product stream.

### BRIEF DESCRIPTION OF THE DRAWINGS

FIG. 1 is a schematic flow chart representation of a preferred batch process useful for the production of consistent quality animal protein products;

FIG. 2 is a schematic flow chart representation of a preferred continuous process useful for the production of consistent quality animal protein products; and

FIG. 3 is a schematic representation of a preferred container for the animal protein products of the invention.

### DETAILED DESCRIPTION OF THE PREFERRED EMBODIMENTS

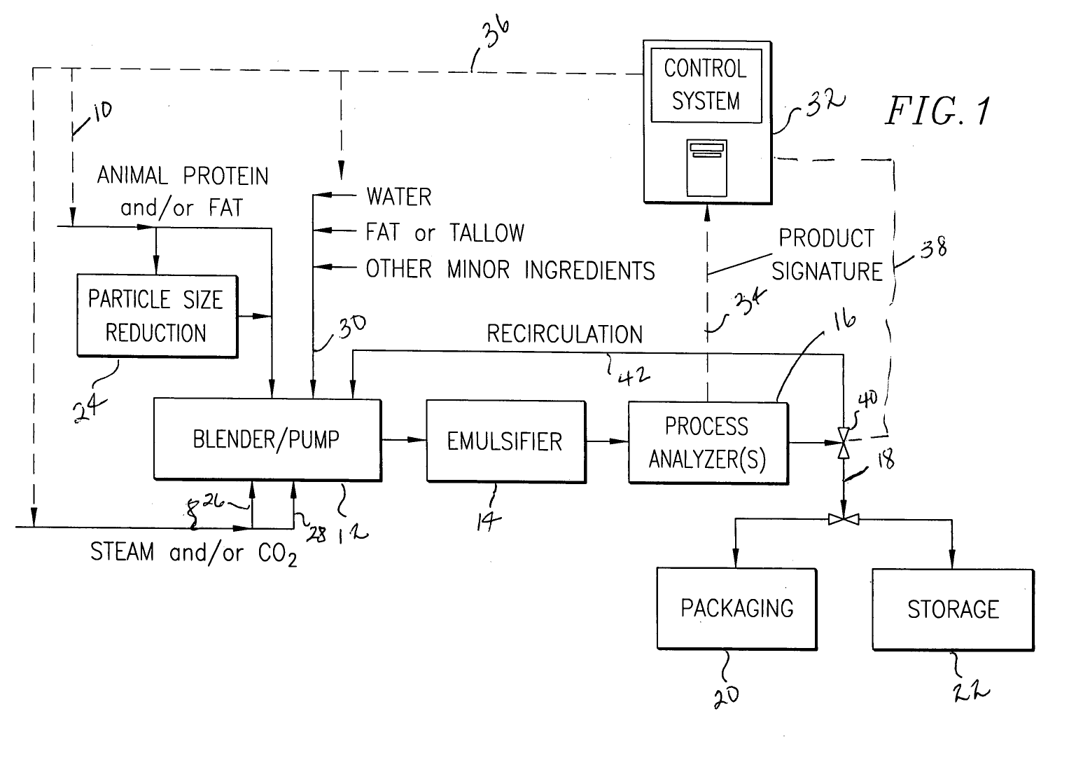

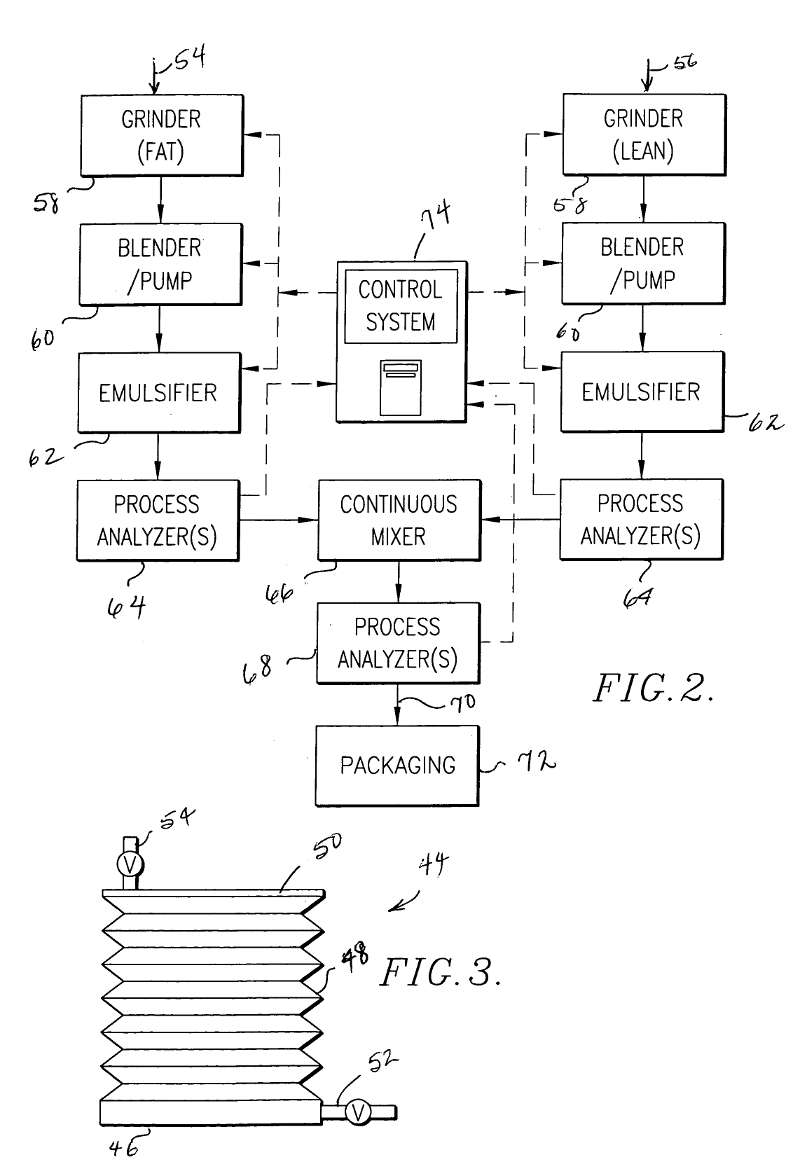

Preferred processes of batch or continuous nature are schematically depicted in FIGS. 1 and 2. Turning first to the batch process of FIG. 1, it will be observed that the overall system is designed to process an incoming stream 10 containing animal protein, fat, and water and to produce the desired output for packaging, storage or immediate use. Broadly speaking, this batch process includes blending in a blending pump or device 12, emulsification using an emulsifier or emulsion mill 14, and analysis employing one or more process analyzers 16. Ultimately, a final product stream 18 is created which can be packaged in conventional packaging equipment 20, or stored such as by refrigeration or freezing at 22. Although not shown, the final stream 18 may also be sent directly to an extruder for immediate use. Also not shown is the option of conducting the operative steps of the process in a CO2 or otherwise reduced oxygen atmosphere.

In more detail, the incoming stream 10 is typically received directly from slaughterhouse operations and as explained above, would contain human or non-human edible animal protein, fat and water. A consistent problem with such incoming products is wide variability in the makeup thereof, a particular problem addressed by the present invention. The initial processing step may include particle size reduction in a grinder 24 or similar device, but this may not be required. In any case, the stream 10, whether or not initially size-reduced, is directed to device 12 where it is blended. In this station, steam and/or carbon dioxide may be added via inputs 26 and 28. Additionally water, fat, tallow or other minor ingredients may also be added through input 30. Again, the function of blending is to move toward the final consistent product desired by the processor.

A variety of blending devices can be used in this context. However, the blender/pump depicted and described in pending application for U.S. Ser. No. 10/713,942 filed Nov. 14, 2003 (incorporated by reference herein) is especially preferred. This type of blender/pump is capable of thoroughly mixing the stream 10 as well as any additions thereto, and to direct this blended stream to emulsifier 14. Such a blender/pump includes twin shafts having a combination of paddles and ribbons that homogeneously mix and convey the material to associated pumping screws. The preferred device operates in such a matter to constantly keep the pumping screws overfull to ensure accurate pumping. The blender is equipped with temperature sensors for monitoring and control, as well as steam/CO2/water/other ingredient inputs. Finally, the blender/pump may be equipped with load cells or level probes to assist in loss-in-weight control and fill level control.

The emulsifier 14 is designed to create a substantially uniform output in terms of viscosity and product size. As noted previously, emulsification should produce a product having solid particles with a maximum dimension of up to about 7 mm, and more preferably up to about 1.5 mm. A number of commercially available emulsifiers or emulsion mills can be used, such as those produced by Cozzini, Inc. The emulsification process will often raise the temperature of the material, and because of this, careful temperature control in the upstream blender is advisable.

Subsequent to emulsification, the material is analyzed using the analyzer(s) 16. Generally speaking, it has been found that improved analyses are obtained with devices which generate energy which is transmitted through a cross section of the material to be analyzed, with analysis data being received and manipulated to obtain useful information. For example, particularly good results have been obtained with near infrared (NIR) analyzers such as those commercialized by ESE, Inc. of Marshfield, Wis., for determining moisture, fat, salts and protein contents, and pH and viscosity values on an instantaneous, real-time basis. Also, guided microwave analyzers such as those produced by Thermoelectron Corporation can be used to measure moisture and fat contents. These types of analyzers have a transmitter positioned adjacent the stream of material and an opposed receiver, so that the energy signal is transmitted through the product. This is to be contrasted with other types of analyzers which are based on reflectance of a signal off a surface of the product; these types of analyzers do not generate data representative of the entire cross-section of the material. Other types of analyzers which may be used in this context include X-ray and ultrasound analyzers, particularly for contaminate detection.

The data generated by the analyzer(s) 16 is directed to a system control microprocessor 32 which is operatively coupled via leads 34, 36 and 38 to the analyzer(s) 16, the additive input 30 and the incoming stream 10, and recycle valve 40 for control purposes. Those skilled in the art will appreciate that these leads are coupled to appropriate pumps or valves in order to control the operation of the overall system.

Depending upon the data received from the analyzer(s) 16, a so-called “product signature” is generated in microprocessor 32. This signature is used in the control of the overall system so as to ensure that the final product stream 18 is of desired characteristics. Such control may include recirculation of a portion of the output from analyzer(s) 16 through line 42 back to blender/pump 12. Also, it may involve addition of water, fat/tallow or other minor ingredients through input 30 and/or addition of fresh quantities of animal protein from incoming stream 10 and/or a dried animal or vegetable-based protein source. Hence, the system can generate the final product stream 18 for packaging at using equipment 20 or storage as at 22. It will be understood that the key to production of the consistent output final product is the accurate analysis of the emulsified product via the analyzer(s) 16.

In actual operation using the system of FIG. 1, the incoming animal protein product is fresh or frozen and would commonly have an average particle size of in excess of about two inches. The product may initially be reduced at 24 (particularly with large average particle sizes above two inches or more; if the average particle size is less than about two inches, initial reduction may not be required) or fed directly to blender/pump 12. The latter is filled to a predetermined level of either volume or weight, and is designed to homogeneously mix the incoming product. Once a fill level is reached and the desired degree of mix is obtained, a material is pumped out of the blender through the emulsifier 14 and then to the process analyzer(s) 16. The information accumulated from the analyzer 16 is used to determine the batch product signature, containing all information that is critical to the final product specification. If recirculation is required, a portion of the analyzed material is directed through line 42 back to blender/pump 12. Also, during the steps of the FIG. 1 process, the temperature of the material is monitored so that if the temperature is too low, steam injection may be used at blender/pump 12 fat and water levels may be increased at the blender/pump 12 through the input lines 30. If contaminates are detected by the analyzer 16, such can be diverted using a diversion valve (not shown). Once the batch is homogeneous and the desired ingredient make up and temperature have been achieved, the product 18 is directed for downstream use or packaging as explained.

Turning next to FIG. 3, a typical container 44 useful for the products of the invention is illustrated. In this case, the container 44 is of square or circular cross-section, including a base 46, a collapsible upstanding side wall 48 and top cover 50 which seals the container against entrance of atmospheric air. Additionally, the container 44 has a lower, valved product removal outlet 52 allowing product to be pumped from the container, as well as a valved relief port at cover 50, which will vent the container 44 if spoilage occurs. Thus, the final product from the FIG. 1 system may be packaged in container such as that illustrated in FIG. 3 for delivery to a processor.

The system of FIG. 1 is in the form of a batch process. FIG. 2 illustrates a similar system which is continuous. This system is very similar to that shown in application Ser. No. 10/713,942. In the FIG. 2 system two separate incoming product lines 54, 56 which are of different characteristics respectively, e.g., a higher fat content animal protein product in line 54, and a leaner animal protein product in line 56. Each of the inputs is subjected to the same steps, namely grinding in a grinder 58 followed by blending in a blender/pump 60, emulsification in a food emulsifier 62 and analysis by process analyzer(s) 64. The output from each process analyzer is then fed to a continuous mixer 66 such as that described in the aforementioned patent application, whereupon the output from the mixer 66 is again analyzed at 68 to generate a final product 70 leading to packaging station 72. It will also be seen that a microprocessor controller 74 is provided which is operatively connected via leads to the grinders, blender/pumps, emulsifiers, and analyzer(s) 64 and 70. Also, as in the case of the FIG. 1 system, the operative steps of the process may all be carried out under CO2 or other reduced oxygen environments. Appropriate temperature sensors (not shown) are also provided throughout each of the steps of the process so as to ensure that proper temperatures are maintained; as necessary, steam or other temperature control media may be injected into the respective blender/pumps 60 or at any other convenient location along the process. Of course, the ultimate goal again is to produce a consistent product for use in an extrusion operation.

The generation of product signatures from each of the inputs 54, 56 is carried out by the control microprocessor 74 as explained previously. Similarly, the microprocessor 74 controls the various operations of each input line to achieve the final product 70, in the manner explained above in connection with the FIG. 1 batch system.

Concurrently filed applications for U.S. Letters Patent entitled Method and Apparatus for Providing Products of Consistent Properties for Extrusion (Ser. No. ______, filed ______) and Method and Apparatus for Providing Instantaneous, Real-time Data for Extrusion Process Control (Ser. No. ______ , filed ______) are incorporated by reference herein.

1. An animal protein product, comprising:
a container sealed against entrance of atmospheric air; and
a quantity of fresh, uncooked animal protein-containing material within said sealed container, said material comprising from about 45-80% by weight water, from up to about 50% by weight protein, from up to about 40% fat and up to about 6% ash,
said material being emulsified to include solid particles having a maximum dimension of up to about 7 mm,
said material having a pH of from about 4-5.5,
there being less than about 5% by weight free oxygen within said sealed container,
said material being storable within said container at room temperature and without spoilage for a period of at least about 7 days.

2. The product of claim 1, said pH being from about 4.3-4.8.

3. The product of claim 1, said protein content being from about 8-18% by weight.

4. The product of claim 1, said fat content being from about 8-20% by weight.

5. The product of claim 1, said material comprising meat or meat by-products derived from poultry, beef, pork, lamb and mixtures thereof.

6. The product of claim 1, said material being storable for a period of at least about 30 days.

7. The product of claim 1, there being less than about 2% by weight free oxygen within said sealed container.

8. The product of claim 1, said particle size being up to about 1.5 mm.

9. The product of claim 1, said container including a valved outlet port permitting removal of said material from the container.

10. The product of claim 1, said container being collapsible during removal of said material from the container.

11. The product of claim 1, said container including a valved relief port.

12. A method of preparing fresh animal protein products useful as ingredients in extrusion, said method comprising the steps of:
providing an incoming aqueous stream of material including fresh, uncooked animal protein and fat;
blending said stream in a blender with the optional addition of additives to said blender;
emulsifying said blended stream such that the blended stream includes solid particles having a maximum dimension of up to about 2 mm;
using an analyzer to analyze said emulsified material to determine at least the moisture content thereof;
creating an output stream downstream of said analyzer; and
adjusting the characteristics of said output stream in response to said analysis by addition of further quantities of animal protein and/or fat and/or said additives thereto.

13. The method of claim 12, said adjusting step comprising the step of recirculating at least a portion of said analyzed stream by addition of said portion to said blender.

14. The method of claim 12, said adjusting step comprising the step of adding ingredients selected from the group consisting of water, fat, and/or animal or vegetable-based protein to said blender.

15. The method of claim 12, including the step of storing data from said analysis in a microprocessor operably coupled with said blender and said analyzer, and using said microprocessor to control the operation of said blender.

16. The method of claim 12, including the step of reducing the particle size of said stream prior to entrance thereof into said blender.

17. The method of claim 12, including the step of adding steam and/or carbon dioxide to said blender.

18. The method of claim 12, said step of adding additional animal protein to said stream comprising the step of directing said analyzed stream and another, separate stream including animal protein and fat to a mixer, and mixing the respective streams therein.

19. The method of claim 12, said method being a batch method.

20. The method of claim 12, said method being a continuous method.

21. The method of claim 12, said analysis step including the steps of analyzing the stream to determine the protein and fat content thereof, and also the pH thereof.

22. The method of claim 12, said analyzer selected from the group consisting of microwave, infrared, X-ray and ultrasound analyzers.

23. The method of claim 22, including the step of using a plurality of said analyzers to analyze said emulsified material.
